(19) United States
(12) Patent Application Publication
(10) Pub. No.: US 2021/0114550 A1
(43) Pub. Date: Apr. 22, 2021

(54) WEBBING TAKE-UP DEVICE

(71) Applicant: KABUSHIKI KAISHA TOKAI-RIKA-DENKI-SEISAKUSHO, Aichi (JP)

(72) Inventors: Kazuhiro YAMADA, Aichi (JP); Tomoya OWAKI, Aichi (JP); Takuhiro SAITO, Aichi (JP)

(21) Appl. No.: 16/970,228

(22) PCT Filed: Jan. 29, 2019
(86) PCT No.: PCT/JP2019/003008

§ 371 Date: Aug. 14, 2020

(30) Foreign Application Priority Data
Feb. 23, 2018 (JP) 2018-030624

(51) Int. Cl. B60R 22/343

(52) U.S. Cl. CPC B60R 22/343

(57) ABSTRACT

In a webbing take-up device, when a lock tooth of a pawl is being rotated toward a lock base, a leading end of the lock tooth is rotated to between leading ends of ratchet teeth of the lock base. This enables the leading end of the lock tooth to be suppressed from colliding with the leading ends of the ratchet teeth.

### TECHNICAL FIELD

The present invention relates to a webbing take-up device in which a moving member is moved by an electrical operation such that pull-out direction rotation of a spool is restricted.

### BACKGROUND ART

In a seatbelt take-up device disclosed in Japanese Patent Application Laid-Open (JP-A) No. 2002-234417, a pawl is moved by electrical operation of a motor so as to mesh with a tooth of a ratchet gear in order to lock rotation of the ratchet gear in an unwinding direction, and lock rotation of a spool in the unwinding direction.

In this seatbelt take-up device, there is a possibility of the pawl colliding with a leading end of a tooth of the ratchet gear when the pawl is moved.

### SUMMARY OF INVENTION

### Technical Problem

In consideration of the above circumstances, an object of the present invention is to obtain a webbing take-up device capable of suppressing a collision between leading ends of engagement teeth and a moving member.

### Solution to Problem

A webbing take-up device of a first aspect of the present invention includes a spool configured to take up webbing for fitting over an occupant and to rotate in a pull-out direction when the webbing is pulled out; a rotation section configured to rotate accompanying rotation of the spool; a moving member configured to be moved by an electrical operation; a plurality of engagement teeth that are provided along a rotation direction of the rotation section, the moving member being configured to move and engage with at least one of the engagement teeth so as to restrict rotation of the rotation section such that rotation of the spool in the pull-out direction is restricted; and a control section configured to perform control such that the moving member is moved to between leading ends of the engagement teeth.

A webbing take-up device of a second aspect of the present invention is the webbing take-up device of the first aspect of the present invention, further including a detection mechanism configured to detect a rotation state of the rotation section, such that the moving member is moved based on the detected rotation state of the rotation section.

A webbing take-up device of a third aspect of the present invention is the webbing take-up device of the first aspect or the second aspect of the present invention, wherein a movement speed of the moving member is regulated.

### Advantageous Effects of Invention

In the webbing take-up device of the first aspect of the present invention, the webbing for fitting over an occupant is taken up on the spool, and when the webbing is pulled out from the spool, the spool is rotated in the pull-out direction. The rotation section also rotates accompanying the rotation of the spool. The plural engagement teeth are provided along the rotation direction of the rotation section, and the moving member is moved by the electrical operation so as to engage with at least one of the engagement teeth in order to restrict rotation of the rotation section such that rotation of the spool in the pull-out direction is restricted.

The control section performs control such that the moving member is moved to between the leading ends of the engagement teeth. This enables a collision between the leading ends of the engagement teeth and the moving member to be suppressed.

In the webbing take-up device of the second aspect of the present invention, the moving member is moved based on the rotation state of the rotation section as detected by the detection mechanism. This enables the precision with which the moving member is moved to between the leading ends of the engagement teeth to be improved.

In the webbing take-up device of the third aspect of the present invention, the movement speed of the moving member is regulated. This enables the precision with which the moving member is moved to between the leading ends of the engagement teeth to be improved.

### BRIEF DESCRIPTION OF DRAWINGS

FIG. 1 is a side view illustrating a webbing take-up device according to a first exemplary embodiment of the present invention, as viewed from the left.

FIG. 2A is a side view illustrating the webbing take-up device according to the first exemplary embodiment of the present invention as viewed from the left, in a state in which rotation of a lock base is permitted.

FIG. 2B is a side view illustrating the webbing take-up device according to the first exemplary embodiment of the present invention as viewed from the left, in a state in which pull-out direction rotation of the lock base is in the process of being locked.

FIG. 2C is a side view illustrating the webbing take-up device according to the first exemplary embodiment of the present invention as viewed from the left, in a state in which pull-out direction rotation of the lock base is locked.

FIG. 3A is a graph illustrating a relationship of solenoid voltage (vertical axis) against time (horizontal axis) when locking pull-out direction rotation of the lock base in the webbing take-up device according to the first exemplary embodiment of the present invention.

FIG. 3B is a graph illustrating a relationship of pawl speed (vertical axis) against time (horizontal axis) when locking pull-out direction rotation of the lock base in the webbing take-up device according to the first exemplary embodiment of the present invention.

FIG. 4 is a flowchart illustrating lock control by a lock mechanism of the webbing take-up device according to the first exemplary embodiment of the present invention.

FIG. 5 is a side view illustrating a webbing take-up device according to a second exemplary embodiment of the present invention, as viewed from the left.

### DESCRIPTION OF EMBODIMENTS

### First Exemplary Embodiment

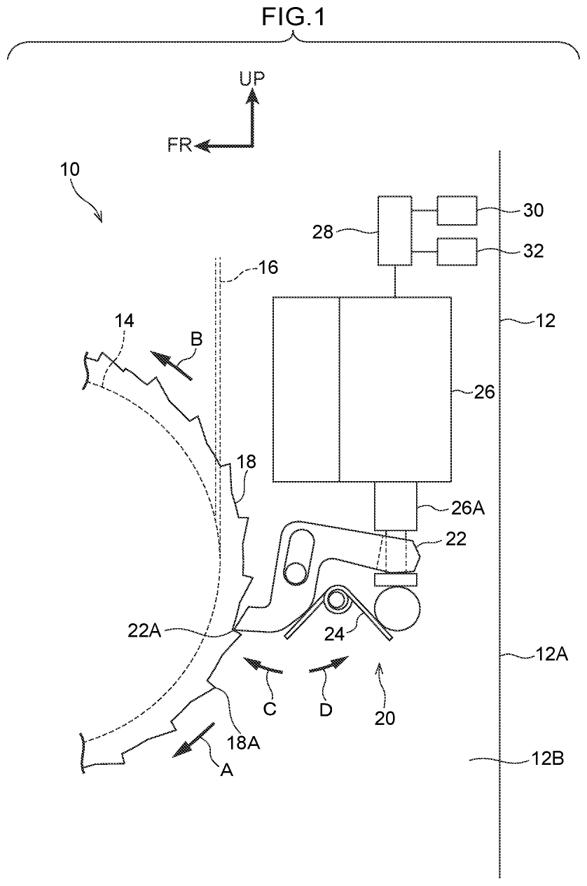

FIG. 1 is a side view illustrating a webbing take-up device 10 according to a first exemplary embodiment of the present invention, as viewed from the left.

As illustrated in FIG. 1, the webbing take-up device 10 according to the present exemplary embodiment includes a frame 12 that has a substantially U-shaped plate shape. The frame 12 is provided with a back plate 12A at a rear side, a leg plate 12B on a left side, and a leg plate (not illustrated in the drawings) on a right side. The frame 12 is fixed to a vehicle body of a vehicle.

A substantially circular column shaped spool 14 is rotatably supported between the left side leg plate 12B and the right side leg plate of the frame 12. The spool 14 is disposed with its axial direction parallel to the left-right direction, and is exposed to the left side through the leg plate 12B. Elongated belt shaped webbing 16 is taken up onto the spool 14 from a length direction base end side. When the spool 14 is rotated in a take-up direction (the arrow A direction in FIG. 1, etc.), the webbing 16 is taken up onto the spool 14. When the webbing 16 is pulled out from the spool 14, the spool 14 is rotated in a pull-out direction (the arrow B direction in FIG. 1, etc.). The spool 14 is urged toward the take-up direction by an urging mechanism (not illustrated in the drawings). The webbing 16 is pulled out from the spool 14 against the urging force of the urging mechanism to be fitted over an occupant of the vehicle.

A lock base 18, serving as a rotation section, is coaxially coupled to the left side of the spool 14. The lock base 18 is capable of rotating as a unit with the spool 14, and is disposed on the left side of the leg plate 12B of the frame 12. Plural ratchet teeth 18A, serving as engagement teeth, are formed to an outer periphery of the lock base 18. Each of the ratchet teeth 18A has a triangular shaped cross-section. The plural ratchet teeth 18A are disposed at uniform spacings along the circumferential direction of the lock base 18, and a leading end (tip) of each of the ratchet teeth 18A is disposed running parallel to the axial direction of the lock base 18.

A lock mechanism 20, serving as a restricting mechanism, is installed on the left side of the leg plate 12B of the frame 12 and at the rear side of the lock base 18.

A substantially L-shaped plate shaped pawl 22, serving as a moving member, is provided to the lock mechanism 20. An intermediate portion of the pawl 22 is rotatably (movably) supported by the leg plate 12B. A trapezoidal plate shaped lock tooth 22A, serving as a restricting tooth, is formed to a leading end portion of the pawl 22. The lock tooth 22A projects toward the lock base 18, and a leading end (tip) of the lock tooth 22A is disposed running parallel to the axial direction of the lock base 18. When the pawl 22 is rotated in a locking direction (the arrow C direction in FIG. 1, etc.), the lock tooth 22A is rotated toward the lock base 18 (the ratchet teeth 18A). When the pawl 22 is rotated in a release direction (the arrow D direction in FIG. 1, etc.), the lock tooth 22A is rotated toward an opposite side from the lock base 18 (an opposite side from the ratchet teeth 18A).

A spring 24 (helical torsion spring), serving as an urging member, is provided at the lower side of the pawl 22. A central portion of the spring 24 is supported by the leg plate 12B. One end of the spring 24 engages with a leading end side portion of the pawl 22, and another end of the spring 24 engages with the leg plate 12B, such that the spring 24 urges the pawl 22 in the locking direction.

A solenoid 26, serving as a drive device, is provided at the upper side of the pawl 22. The solenoid 26 is fixed to the leg plate 12B. The solenoid 26 is provided with a plunger 26A. The plunger 26A extends toward the lower side, and a base end portion of the pawl 22 is swingably coupled to a leading end portion (lower end portion) of the plunger 26A.

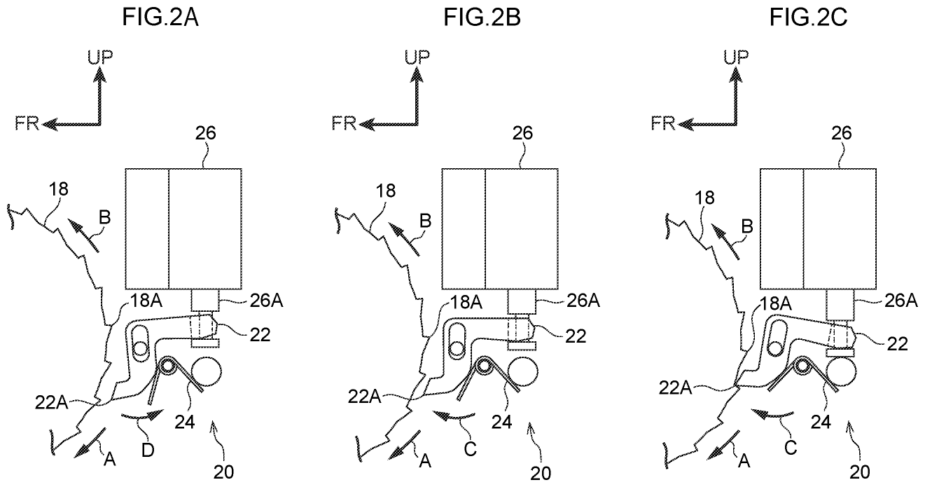

A control device 28, serving as a control section, is electrically connected to the solenoid 26. When current is passed through the solenoid 26 at a release voltage (high voltage) under the control of the control device 28, the solenoid 26 is electrically release-operated, such that the plunger 26A of the solenoid 26 is attracted toward the upper side by a high load, and is moved toward an opposite side from the pawl 22 (see FIG. 2A). The pawl 22 is thereby rotated in the release direction against the urging force of the spring 24, and the lock tooth 22A of the pawl 22 is moved away from the lock base 18.

A detecting mechanism 30 is electrically connected to the control device 28. The detecting mechanism 30 detects an emergency state of the vehicle (such as at least one of rapid deceleration of the vehicle or the webbing 16 being abruptly pulled out from the spool 14 during a vehicle collision).

A detection mechanism 32 is also electrically connected to the control device 28. The detection mechanism 32 for example detects a rotation angle of the lock base 18, and detects a rotation speed and a rotation position of the lock base 18 (including the ratchet teeth 18A).

Next, explanation follows regarding operation of the present exemplary embodiment.

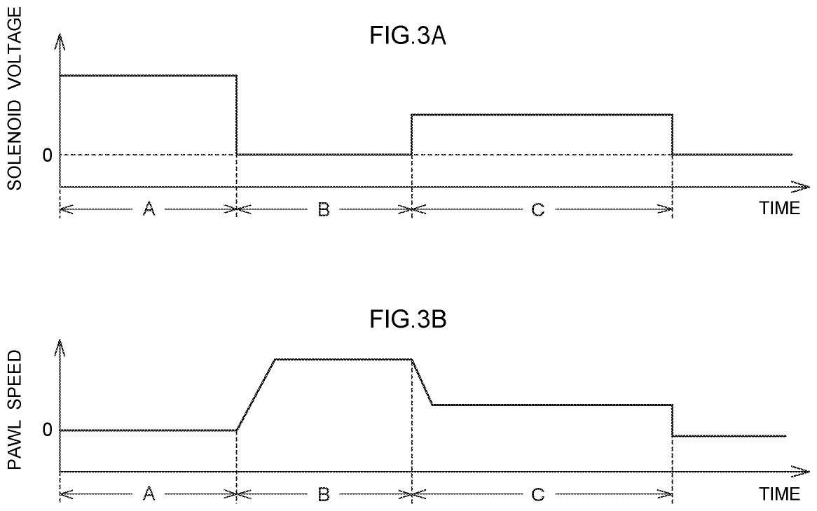

In the lock mechanism 20 of the webbing take-up device 10 with the above configuration, current is passed through the solenoid 26 at the release voltage and release-operated under the control of the control device 28. The lock tooth 22A of the pawl 22 is thereby moved away from the lock base 18, thereby permitting rotation of the lock base 18 and the spool 14 in the take-up direction (arrow A direction) and the pull-out direction (arrow B direction) (see FIG. 2A, and region A in FIG. 3A and FIG. 3B). Moreover, the webbing 16 can be pulled out from the spool 14 against the urging force of the urging mechanism and fitted over the occupant.

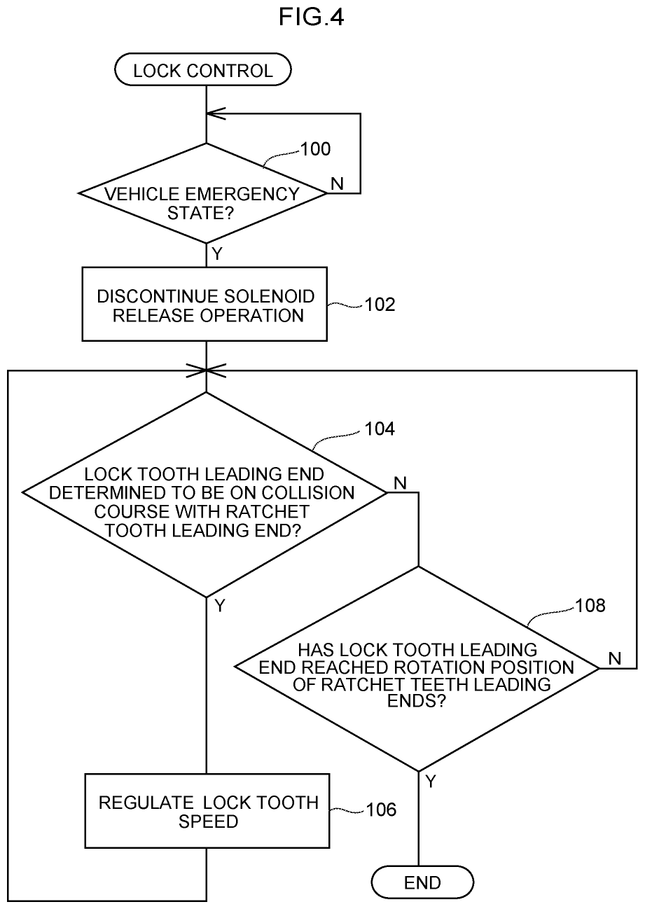

In the lock mechanism 20, the lock control illustrated in FIG. 4 is performed by the control device 28.

First, at step 100, determination is made as to whether or not the detecting mechanism 30 has detected an emergency state of the vehicle. In a case in which determination is made at step 100 that the detecting mechanism 30 has not detected an emergency state of the vehicle, the processing of step 100 is repeated.

In a case in which determination is made at step 100 that the detecting mechanism 30 has detected an emergency state of the vehicle, at step 102 current passing through the solenoid 26 at the release voltage is discontinued, thereby discontinuing the release operation of the solenoid 26. Movement of the plunger 26A of the solenoid 26 toward the pawl 22 is thereby permitted, and the pawl 22 is rotated in the locking direction (arrow C direction) under the urging force of the spring 24, such that the lock tooth 22A of the pawl 22 is rotated toward the lock base 18 (see FIG. 2B, and region B in FIG. 3A and FIG. 3B).

Next, at step 104, determination is made as to whether or not the leading end of the lock tooth 22A of the pawl 22 is on a collision course with the leading end of one of the ratchet teeth 18A of the lock base 18, based on the rotation speed and the rotation position of the lock base 18 as detected by the detection mechanism 32.

In a case in which determination is made at step 104 that the leading end of the lock tooth 22A is on a collision course with the leading end of one of the ratchet teeth 18A, at step 106, the solenoid 26 is regulation-operated by having current passed through a regulating voltage (low voltage). The plunger 26A is thereby attracted toward the upper side by a low load, and the rotation of the pawl 22 (rotation of the lock tooth 22A toward the lock base 18) by the urging force of the spring 24 is slowed or stopped (regulated) (see region C in FIG. 3A and FIG. 3B). The processing of step 104 is then repeated.

In a case in which determination is made at step 104 that the leading end of the lock tooth 22A is not on a collision course with the leading end of one of the ratchet teeth 18A, at step 108, determination is made as to whether or not the leading end of the lock tooth 22A has reached the rotation position (a rotation-radial direction position) of the leading ends of the ratchet teeth 18A. In a case in which determination is made at step 108 that the leading end of the lock tooth 22A has not reached the rotation position of the leading ends of the ratchet teeth 18A, the processing of step 104 is repeated.

In a case in which determination is made at step 108 that the leading end of the lock tooth 22A has reached the rotation position of the leading ends of the ratchet teeth 18A, the lock control is ended. Thus, the lock tooth 22A of the pawl 22 meshes (engages) with one of the ratchet teeth 18A of the lock base 18, and pull-out direction rotation of the lock base 18 is locked (restricted) by the pawl 22, such that pull-out direction rotation of the spool 14 is locked, and the occupant is restrained by the webbing 16 (see FIG. 2C).

Note that as previously described, when the lock tooth 22A of the pawl 22 is rotated toward the lock base 18 and determination is made that the leading end of the lock tooth 22A is on a collision course with the leading end of one of the ratchet teeth 18A of the lock base 18, the rotation speed of the lock tooth 22A toward the lock base 18 is slowed such that the leading end of the lock tooth 22A is rotated to between the leading ends of the ratchet teeth 18A. This enables a collision between the leading end of the lock tooth 22A and the leading ends of the ratchet teeth 18A to be suppressed, thereby enabling damage to the leading end of the lock tooth 22A and the leading ends of the ratchet teeth 18A to be suppressed.

Furthermore, as previously described, as the lock tooth 22A of the pawl 22 is being rotated toward the lock base 18, the rotation speed of the lock tooth 22A toward the lock base 18 is regulated while determining whether or not the leading end of the lock tooth 22A of the pawl 22 is on a collision course with the leading end of one of the ratchet teeth 18A of the lock base 18 based on the rotation speed and the rotation position of the lock base 18 as detected by the detection mechanism 32. This enables the precision with which the leading end of the lock tooth 22A is rotated to between the leading ends of the ratchet teeth 18A to be increased, enabling a collision between the leading end of the lock tooth 22A and the leading ends of the ratchet teeth 18A to be effectively suppressed, and enabling damage to the leading end of the lock tooth 22A and the leading ends of the ratchet teeth 18A to be effectively suppressed.

Moreover, the pawl 22 directly locks pull-out direction rotation of the lock base 18. This enables the time taken to lock pull-out direction rotation of the lock base 18 to be reduced compared to a case in which the pawl 22 locks rotation of an intermediate component located between the pawl 22 and the lock base 18 in order to lock pull-out direction rotation of the lock base 18.

### Second Exemplary Embodiment

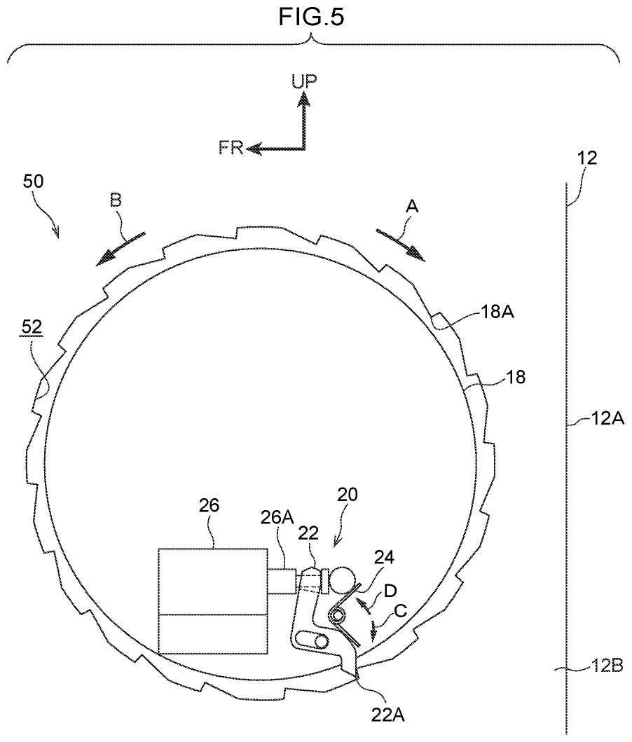

FIG. 5 is a side view illustrating a webbing take-up device 50 according to a second exemplary embodiment of the present invention, as viewed from the left.

The webbing take-up device 50 according to the present exemplary embodiment has basically the same configuration as the first exemplary embodiment, but differs in the following points.

As illustrated in FIG. 5, in the webbing take-up device 50 according to the present exemplary embodiment, a substantially circular shaped ratchet hole 52 is formed through the leg plate 12B of the frame 12, and the ratchet teeth 18A are formed to a peripheral portion of the ratchet hole 52 instead of to the lock base 18.

The pawl 22, the spring 24, and the solenoid 26 of the lock mechanism 20 are provided on the left side of the lock base 18 instead of on the leg plate 12B of the frame 12. The pawl 22, the spring 24, and the solenoid 26 are capable of rotating as a unit with the lock base 18.

Note that in the present exemplary embodiment, lock control of the lock mechanism 20 is performed by the control device 28 similarly to in the first exemplary embodiment, such that the lock tooth 22A of the pawl 22 on the lock base 18 meshes with one of the ratchet teeth 18A of the ratchet hole 52 in the leg plate 12B such that pull-out direction rotation of the lock base 18 is locked by the pawl 22. Thus, the present exemplary embodiment is capable of exhibiting similar operation and advantageous effects to those in the first exemplary embodiment.

Note that in the first exemplary embodiment and the second exemplary embodiment, the lock tooth 22A of the pawl 22 is made to rotate toward the lock base 18 or the ratchet hole 52 under the urging force of the spring 24. However, the lock tooth 22A of the pawl 22 may be made to rotate toward the lock base 18 or the ratchet hole 52 by electrical operation of the solenoid 26.

Moreover, in the first exemplary embodiment and the second exemplary embodiment, the rotation speed of the lock tooth 22A of the pawl 22 toward the lock base 18 or the ratchet hole 52 is slowed by regulating the voltage at which current is passed through the solenoid 26. However, the rotation speed of the lock tooth 22A of the pawl 22 toward the lock base 18 or the ratchet hole 52 may be slowed by causing a frictional force to act on the pawl 22.

Furthermore, in the first exemplary embodiment and the second exemplary embodiment, the solenoid 26 is employed as a drive device. However, an electromagnet may be employed as a drive device.

Moreover, in the first exemplary embodiment and the second exemplary embodiment, the pawl 22 restricts rotation of the lock base 18. However, the pawl 22 may restrict rotation of a V gear (a rotation section) located between the pawl 22 and the lock base 18. In such cases, the V gear is configured so as to be capable of rotating together with the lock base 18, and a restricting member is provided between the V gear and one of the lock base 18 or the leg plate 12B. Thus, in an emergency state of the vehicle, the pawl 22 on one of the leg plate 12B or the V gear meshes with the ratchet teeth 18A on another of the leg plate 12B or the V gear in order to restrict pull-out direction rotation of the V gear. Furthermore, when the lock base 18 is rotated in the pull-out direction relative to the V gear and the restricting member is moved, the restricting member engages with another of the lock base 18 or the leg plate 12B so as to lock pull-out direction rotation of the lock base 18.

The entire content of the disclosure of Japanese Patent Application No. 2018-30624 filed on Feb. 23, 2018 is incorporated by reference in the present specification.

### EXPLANATION OF REFERENCE NUMERALS

10 webbing take-up device
14 spool
16 webbing
18 lock base (rotation section)
18A ratchet teeth (engagement teeth)
22 pawl (moving member)
28 control device (control section)
32 detection mechanism
50 webbing take-up device

1. A webbing take-up device comprising:
a spool configured to take up webbing for fitting over an occupant and to rotate in a pull-out direction when the webbing is pulled out;
a rotation section configured to rotate accompanying rotation of the spool;
a moving member configured to be moved by an electrical operation;
a plurality of engagement teeth that are provided along a rotation direction of the rotation section, the moving member being configured to move and engage with at least one of the engagement teeth so as to restrict rotation of the rotation section such that rotation of the spool in the pull-out direction is restricted; and
a control section configured to perform control such that the moving member is moved to between leading ends of the engagement teeth.

2. The webbing take-up device of claim 1, further comprising a detection mechanism configured to detect a rotation state of the rotation section, such that the moving member is moved based on the detected rotation state of the rotation section.

3. The webbing take-up device of claim 1, wherein a movement speed of the moving member is regulated.

4. The webbing take-up device of claim 1, wherein movement of the moving member is regulated in a case in which it is determined that the moving member will collide with the leading end of one of the engagement teeth.

5. The webbing take-up device of claim 4, wherein determination is made as to whether or not the moving member will collide with the leading end of one of the engagement teeth, until the moving member reaches a position of the leading ends of the engagement teeth in a rotation-radial direction of the rotation section.

6. The webbing take-up device of claim 1, further comprising:
an urging member configured to urge the moving member toward the engagement teeth; and
a drive device configured to cause a force resisting an urging force of the urging member to act on the moving member.

7. The webbing take-up device of claim 1, further comprising a drive device configured to move the moving member toward the engagement teeth.
